(19) United States
(12) Patent Application Publication
(10) Pub. No.: US 2023/0405522 A1
(43) Pub. Date: Dec. 21, 2023

(54) LIQUID CARBON DIOXIDE CAPTURING FILTER SYSTEM AND METHOD

(71) Applicant: Purdue Research Foundation, West Lafayette, IN (US)

(72) Inventors: Maria Mirian Velay Lizancos, West Lafayette, IN (US); Luciano Castillo, Carmel, IN (US); Helber Antonio Esquivel-Puentes, Lafayette, IN (US)

(21) Appl. No.: 18/199,554

(22) Filed: May 19, 2023

Related U.S. Application Data
(60) Provisional application No. 63/343,610, filed on May 19, 2022.

(51) Int. Cl. B01D 53/86; B01D 53/90

(52) U.S. Cl. CPC B01D 53/864; B01D 53/90; B01D 2252/1035; B01D 2251/604; B01D 2257/504; B01D 2258/06

(57) ABSTRACT

The carbon dioxide filter system includes a reservoir, a solvent, an injector coupled to the reservoir, an exhaust port, and a collection chamber. The solvent is disposed in the reservoir. The injector, the exhaust port, and the collection chamber are each coupled to the reservoir. The solvent includes a hydroxide. The injector includes a fan configured to direct polluted air containing carbon dioxide to the reservoir. The polluted air containing carbon dioxide reacts with the hydroxide of the solvent. The reaction may separate the carbon dioxide from the air, thus forming a liquid filter. The reaction produces a by-product that is separable from the solvent.

### CROSS REFERENCE TO RELATED APPLICATIONS

The present application is a U.S. non-provisional application which claims the benefit of U.S. provisional application Ser. No. 63/343,610, filed May 19, 2022, the content of which is incorporated by reference herein in its entirety.

### FIELD

The disclosure generally relates to filters systems and, more particularly, to carbon dioxide capturing filter systems.

### INTRODUCTION

This section provides background information related to the present disclosure which is not necessarily prior art.

The global CO₂ emissions have been increasing exponentially over the last 150 years. The high concentrations of CO₂ in the atmosphere are contributing to global warming and ocean acidification, among other important issues for our planet and our economy. The need of direct capture carbon technologies is very high right now and more efficient technologies are required to address this big challenge.

Accordingly, there is a continuing need for a more economical and sustainable system for capturing carbon dioxide.

### SUMMARY

In concordance with the instant disclosure, a more economical and sustainable system for capturing carbon dioxide, has surprisingly been discovered. Desirably, the carbon dioxide filter system may be self-sustaining, militates against carbon dioxide pollution, and recycles various resources.

In this disclosure, a carbon dioxide filter system includes a reservoir, a solvent, an injector coupled to the reservoir, an exhaust port, and a collection chamber. The solvent may include water. In a specific example, the solvent may contain a hydroxide disposed within the reservoir, such as calcium hydroxide. The solvent containing the hydroxide may provide a liquid filter for carbon dioxide. The injector may include a fan. The fan may be configured to direct a gas containing carbon dioxide to the reservoir. The carbon dioxide filter system may be configured to react the gas containing carbon dioxide with the solvent. In a specific example, the byproducts of the reaction may include calcium carbonate and a gas that is substantially free of carbon dioxide and/or carbon monoxide. In a specific example, the carbon dioxide filter system may utilize a decantation process to separate the calcium carbonate from the solvent.

This process may use water coming out from the corn processing industry since the liquid is a residue containing hydroxides. The integration of wind energy with the fluid capturing filter benefits the CO₂ capture process in many areas such as big and industrialized cities, corn processing plants, and various other carbon dioxide producing facilities. In certain circumstances, the carbon dioxide capturing filtering system may militate against and/or eliminate emissions due to the integration with clean energy such as wind energy to power the process. The role of the wind turbine is to provide the energy to the carbon dioxide capturing filtering system but also to lead the polluted air towards the intake of the reservoir where it may be mixed with the filtering fluid. A hydraulic wind turbine that provides modularity and flexibility to the power transmission may be integrated into the system in order to power the filtering process since the power output of the turbine transmission is at the reservoir level. Advantageously, the relocation of the output of the system at the ground level may permit having power available without using the electric stage of the energy conversion. Also, the system provides the capability to control the output angular velocity since the pump and motor have different rotational speeds. Moreover, for offshore applications important savings in the (Levelized Cost of Energy) LCOE may be based on the modifications to the drivetrain of the wind turbine. Additionally, the energy harvested from wind can be used to recirculate the fluid used as a filter and to inject the polluted air with CO₂ into the reservoir. The use of regular wind turbines, horizontal and vertical axis, are considered to power the filtering process mostly to have multiple options depending on the wind resources available.

In certain circumstances, this reaction may capture CO₂ converting the mix of water with lime to the point that the water is lime saturated plus extra lime. The incorporation of this CO₂ capturing liquid to a hydraulic system that pumps air with CO₂ concentrated will make a mix of water and lime to become a liquid CO₂ capturing material. The filtering process may be carried out in a reservoir that works as mixing chamber, where the CO₂ is injected and mixed with the Ca(OH)₂. The process may be done in a closed loop that will be renewed from time to time in cycles when the filter has reached a maximum CO₂ capacity to be captured. Using the extraction fans, the generated and current CO₂ in the air is filtered reducing the current content of this gas from the environment.

Various ways of using the carbon dioxide filter system are provided. For instance, a method may include a step of providing a reservoir, a solvent, an injector, an exhaust port, and a collection chamber. The solvent may include a hydroxide disposed within the reservoir. The injector, the exhaust port, and the collection chamber may each be coupled to the reservoir. Next, polluted air may be injected into the reservoir of the carbon dioxide filter system. Afterwards, the polluted air may be reacted with the solvent. Then, the carbon dioxide may be filtered from polluted air. The filtered air may then be released from carbon dioxide filter system through the exhaust port. Next, a by-product from the reaction of the polluted air with the solvent may be collected in the collection chamber. In a specific example, the by-product may be calcium carbonate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic view of a carbon dioxide filter system having a reservoir, a solvent, an injector coupled to the reservoir, an exhaust port, and a collection chamber, further depicting the carbon dioxide filter system in a closed loop configuration, according to one embodiment of the present disclosure;

FIG. 2 is a schematic view of the carbon dioxide filter system, as shown in FIG. 1, further depicting the carbon dioxide filter system having a high-concentrated hydroxide supply, according to one embodiment of the present disclosure;

FIG. 3 is a schematic diagram of the carbon dioxide filter system provided as a closed-circuit system, further depicting a tank supplying a hydroxide rich solution to the recycled water to provide the solvent to the reservoir. according to one embodiment of the present disclosure;

FIG. 4 is a top perspective view of an experimental setup for the carbon dioxide filter system, further depicting a compressed carbon dioxide tank providing polluted air to the reservoir, according to one embodiment of the present disclosure;

FIG. 5 is a line graph illustrating the results of the experimental setup, as shown in FIG. 4, further depicting a logarithmic decay of carbon dioxide concentration, according to one embodiment of the present disclosure;

FIG. 6 is a Raman spectra of the products collected from the experimental setup, as shown in FIG. 4, further depicting a characteristic peak at 1086 [1/cm] which indicates the formation of CaCO₃, according to one embodiment of the present disclosure;

FIG. 7 is a schematic diagram of the carbon dioxide filter system configured to remove nitrogen oxides from the polluted air, further depicting a first step wherein the solvent includes titanium dioxide nanoparticles which are excited by a UV Radiation source, according to one embodiment of the present disclosure;

FIG. 8 is a schematic diagram of the carbon dioxide filter system configured to remove nitrogen oxides from the polluted air, as shown in FIG. 7, further depicting a second step wherein the calcium nitrate containing solvent is recycled back to into the reservoir and further breaking down the nitrogen oxide molecules by the UV Radiation source, according to one embodiment of the present disclosure;

FIG. 9 is a schematic right-side elevational view of the carbon dioxide filter system, further depicting the carbon dioxide filter system coupled to a hydraulic wind turbine system and disposed on a buoyant structure accepting polluted air from a carbon dioxide producing source, according to one embodiment of the present disclosure;

FIG. 10 is an enlarged schematic right-side elevational view of the carbon dioxide filter system having a reservoir, a solvent, an injector coupled to the reservoir, and a collection chamber, according to one embodiment of the present disclosure;

FIG. 11 is a box diagram of the carbon dioxide filter system coupled to a vehicle, further depicting where the carbon dioxide filter system is disposed after the engine and catalytic converter but before the exhaust, according to one embodiment of the present disclosure;

FIG. 12 is a box diagram illustrating governing equations of wind energy harvesting using a horizontal axis wind turbine, according to one embodiment of the present disclosure;

FIG. 13 is a schematic diagram of the carbon dioxide filter system powered by the hydraulic wind turbine system, further depicting the hydraulic motor of the hydraulic wind turbine system coupled to a circulation pump and/or a gas compressor of the carbon dioxide filter system, according to one embodiment of the present disclosure;

FIG. 14 is a line graph of a wind speed profile used to test the hydraulic wind turbine system, according to one embodiment of the present disclosure;

FIG. 15 is a line graph illustrating the power generated by the hydraulic wind turbine system using a hydrostatic transmission (HT) configuration and a non-controlled transmission, further depicting the HT configuration having a more steady signal compared to the highly fluctuant signal of the non-controlled transmission, according to one embodiment of the present disclosure;

FIG. 16 is a flowchart of a method for using the carbon dioxide filter system, according to one embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below,” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

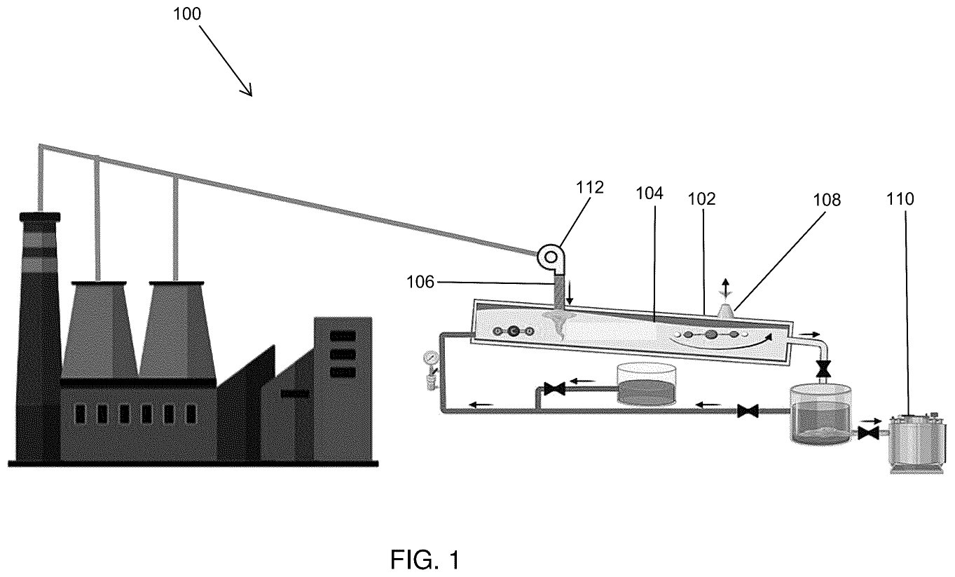

As shown in FIGS. 1-4, the carbon dioxide filter system 100 includes a reservoir 102, a solvent 104, an injector 106 coupled to the reservoir 102, an exhaust port 108, and a collection chamber 110. The solvent 104 may include water. In a specific example, the solvent 104 may contain a hydroxide disposed within the reservoir 102, such as calcium hydroxide. The solvent 104 containing the hydroxide may provide a liquid filter for carbon dioxide. The injector 106 may be include a fan 112. The fan 112 may be configured to direct a gas containing carbon dioxide to the reservoir 102. The carbon dioxide filter system 100 may be configured to react the gas containing carbon dioxide with the solvent 104. In a specific example, a byproduct of the reaction may include calcium carbonate and a gas that is substantially free of carbon dioxide and/or carbon monoxide. The gas that is substantially free of carbon dioxide and/or carbon monoxide may be released through the exhaust port 108. In a specific example, the carbon dioxide filter system 100 may utilize a decantation process to separate the by-product from the solvent 104. In a more specific example, the carbon dioxide filter system 100 may include a return line 111 for recycling the solvent 104 separated from the by-product back to the reservoir 102.

The mixture of hydroxides, such as calcium hydroxide, and water may serve as a liquid CO₂ capturing filter. When air with CO₂ is injected into the liquid filter, the CO₂ of the air may react with the calcium hydroxide and (or with the hydroxide used to make the liquid filter) produce calcium carbonate (CaCO₃) CaCO₃ can be easily separate from the liquid filter by precipitation due to its insolubility in water. Or the water with CaCO₃ can be used in the concrete industry directly to enhance concrete properties. It should be appreciated that other hydroxides are contemplated to be utilized with the solvent 104, and the corresponding by-product may be tailored as a function of the hydroxide used.

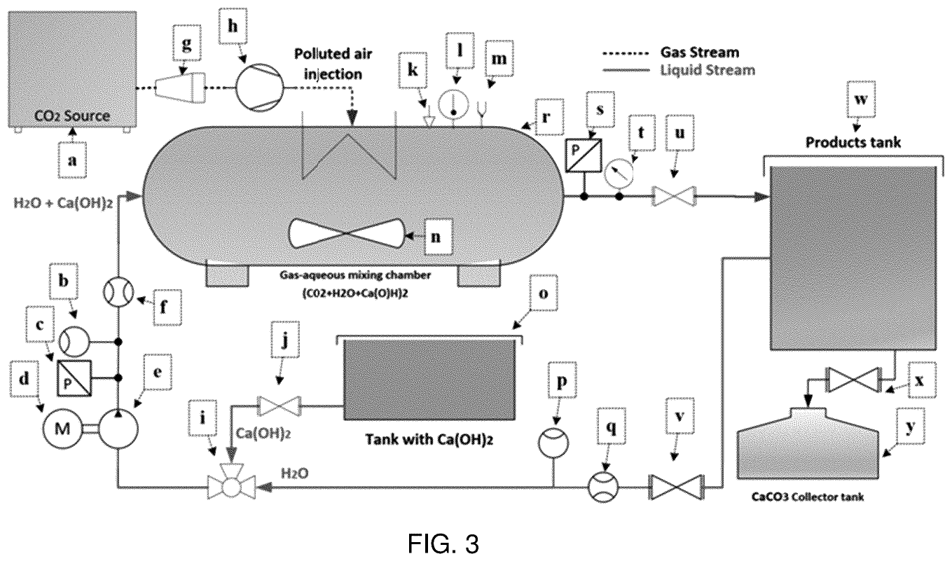

As shown in FIG. 3, the carbon dioxide filter system may be provided as a closed-circuit system. In a specific example, the reservoir 102 may also be known as a gas-aqueous mixing chamber where the reaction between the carbon dioxide and the hydroxide containing solvent occurs and also where the dissociation of the carbon dioxide molecule takes place. In a more specific example, where the solvent contains calcium hydroxide, the carbon atom of the disassociated carbon dioxide molecule may become part of the calcium carbonate product, while oxygen is released. In another non-limiting example, the collection chamber 110 may be also known as the products tank. Water and the produced calcium carbonate may be stored in the products tank. More specifically, the calcium carbonate may precipitate to a bottom area of the products tank while the water may be recirculated. In some circumstances, the carbon dioxide filter system 100 may include a tank with a hydroxide rich solution. The tank with the hydroxide rich solution may be mixed with the recirculated water to replenish the solvent 104 in the reservoir 102.

The carbon dioxide filter system 100 may be powered in various ways. For instance, provided as non-limiting examples, the carbon dioxide filter system 100 may be powered by an electric motor, as shown in FIG. 3. The carbon dioxide filter system 100 may also be powered by a hydraulic motor. In a more specific example, the hydraulic motor may be provided with a wind turbine. One skilled in the art may select other suitable methods to power the carbon dioxide filter system 100. As non-limiting examples, Table 1 below may be referenced to describe additional components of the carbon dioxide filter system 100 shown in FIG. 3.

TABLE 1

| Item | Component |
|---|---|
| a | CO₂ source |
| b | Flow meter transducer |
| c | Pressure sensor |
| d | Electric motor |
| e | Circulation pump |
| f | Mechanical flow meter |
| g | Gas flow meter |
| h | Compressor |
| i | 3-way valve |
| j | On-off valve |
| k | Air release valve |
| l | Thermometer |
| m | Thermocouple |
| n | Chamber mixer |
| o | Calcium hydroxide tank |
| p | Flow meter transducer |
| q | Mechanical flow meter |
| r | Mixing chamber |
| s | Pressure transducer |
| t | Pressure gauge |
| u | On-off valve |
| v | On-off valve |
| w | Products tank |
| x | On-off valve |
| y | Calcium carbonate tank |

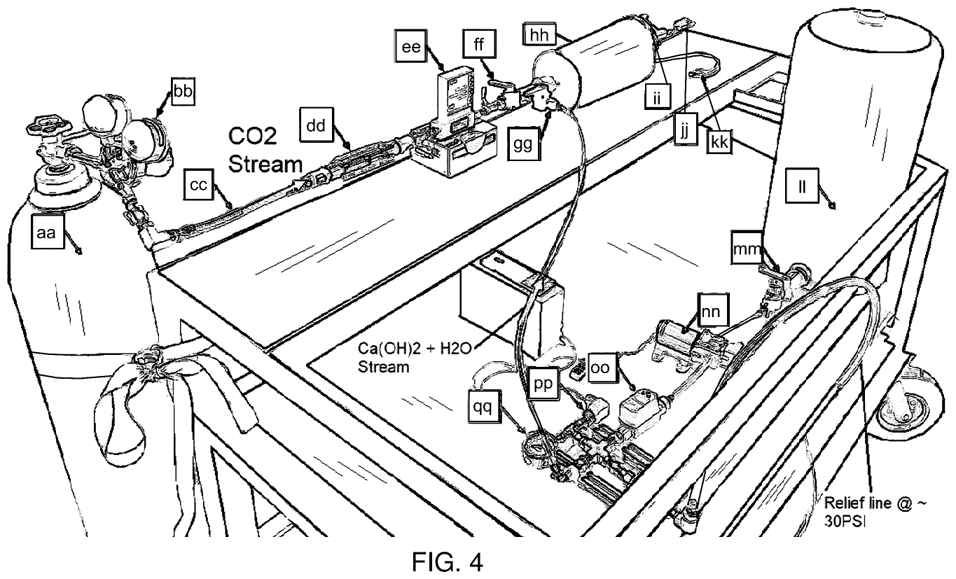

The concept of the carbon dioxide filter system 100 has been experimentally validated using a functional prototype model in the laboratory. As shown in FIG. 4, a laboratory-scale prototype built was to carry out validation experiments using CO₂ injected into the reservoir 102, or otherwise known as a mixing chamber (h). Since a CO₂ source, such as a boiler or internal combustion engine, is not available for the experiment, a compressed CO₂ tank was used to provide the polluted gas. While the solvent 104, which may include a calcium hydroxide solution, may occupy around 60% of the total volume of the mixing chamber. The CO₂ gas may be injected into the mixing chamber (h) until it reaches a pressure build-up of 30 psi. Then, a check valve may be engaged, and the gas line is closed. The CO₂ flow rate is measured using a flow meter transducer (e). The Ca(OH)₂ solution may be injected into the mixing chamber by pumping it from a circulation pump (n) from a solution tank (l). Once the CO₂ and the Ca(OH)₂ are in the mixing chamber, all valves (f, g, i) may be closed. The CO₂ datalogger may be connected to a probe (k) to measure the CO₂ concentration inside the mixing chamber (h). This experiment was carried out at room conditions. A skilled artisan may select other suitable configurations and/or components to provide the carbon dioxide filter system 100. As non-limiting examples, Table 2 on the following page may be referenced to describe additional components of the carbon dioxide filter system 100 shown in FIG. 4.

TABLE 2

| Item | Component |
|---|---|
| aa | CO₂ tank |
| bb | CO₂ regulator |
| cc | CO₂ line |
| dd | Gas flow meter |
| ee | Flow meter transducer |
| ff | Gas on-off vale |
| gg | Liquid on-off valve |
| hh | Mixing chamber |
| ii | Products on-off valve |
| jj | Thermocouple |
| kk | CO₂ datalogger probe |
| ll | Ca(OH)₂ tank |
| mm | On-off valve |
| nn | Circulation pump |
| oo | Liquid flow meter transducer |
| pp | Pressure transducer |
| qq | Pressure gauge |

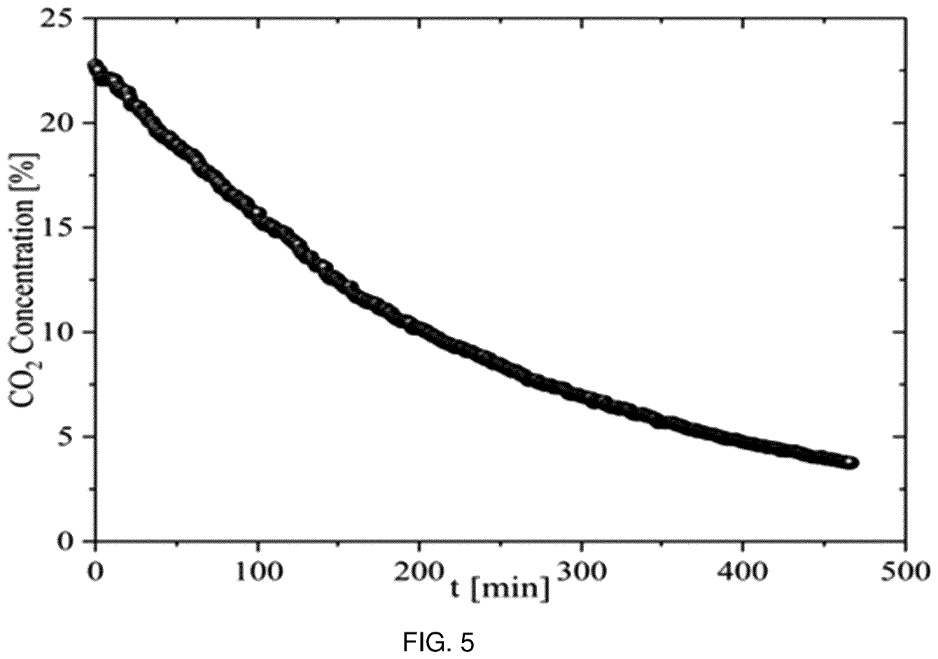

The experimental setup, as shown in FIG. 4, was utilized to determine a concentration of carbon dioxide over time using the carbon dioxide filter system 100. The total solvent 104 used was around two liters, and the initial concentration of CO₂ in the gas fraction in the reservoir 102 was around twenty-two percent. The solvent 104 was prepared using around 0.73 g of Ca(OH)₂ per around 500 g of water. The temperature, pressure, and humidity were at room conditions. As shown in FIG. 5, the CO₂ concentration had a logarithmic decay. Ideal parameters are the main target to achieve a higher negative slope of the curve, which represents a faster reaction. Temperature and pH are two of the main variables considered for exploration. Achieving a faster reaction may allow for a smaller and lighter system, which would be more beneficial for mobile applications.

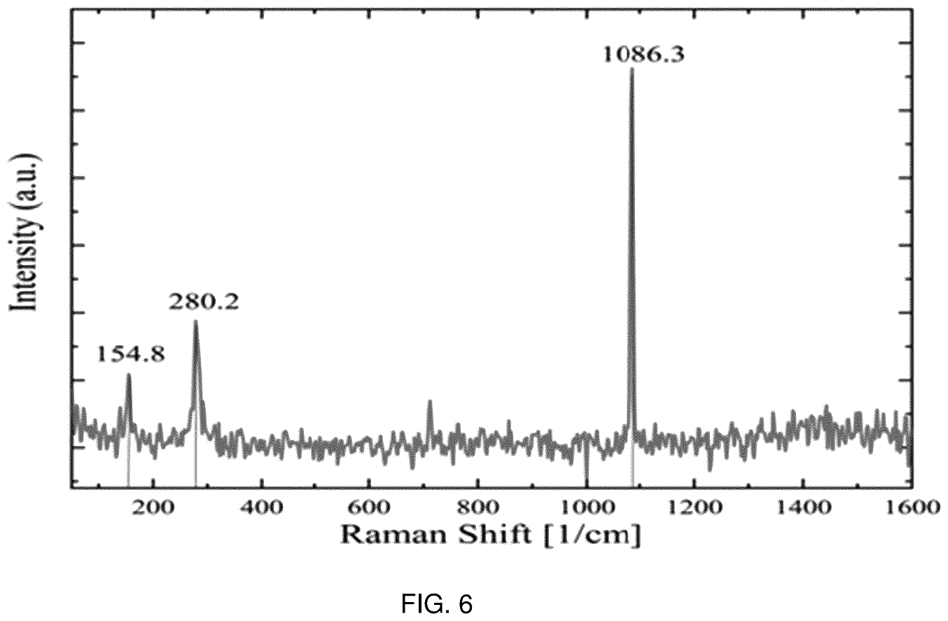

Once the capturing process is completed, the products were collected and characterized using Raman spectroscopy, as shown in FIG. 6. A characteristic peak at 1086 [1/cm] confirms the formation of CaCO₃. Based on the frequencies of the two more intense peaks, the formation of calcite is a tentative initial conclusion.

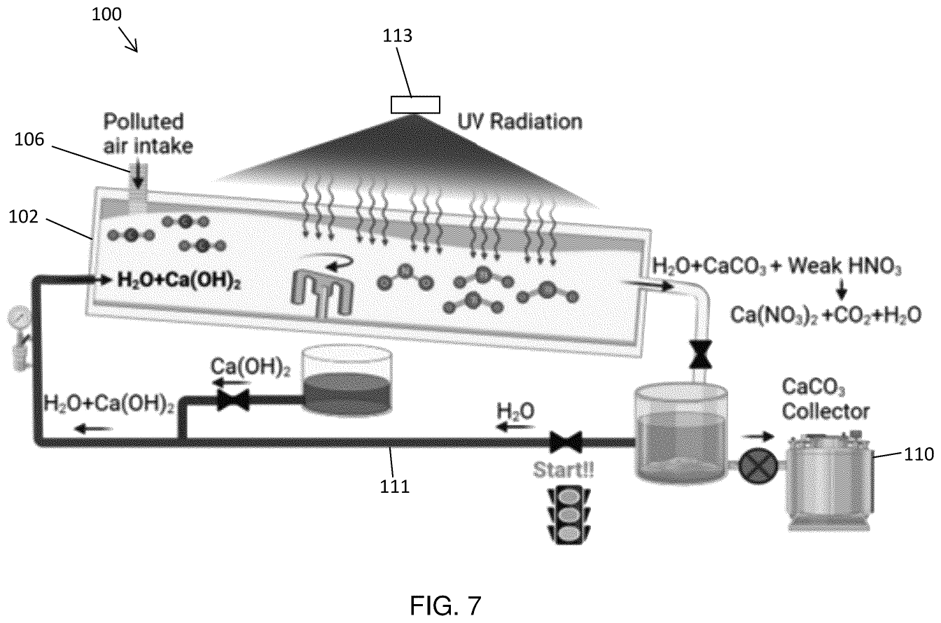

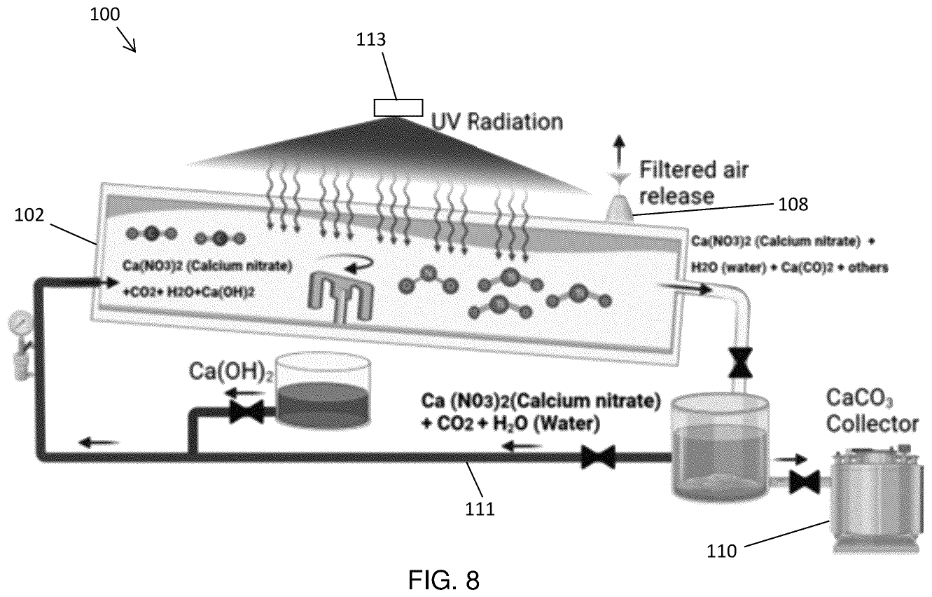

In certain circumstances, the carbon dioxide filter system 100 may include ways to filter and/or breakdown various pollutant gases, aside from carbon dioxide. For instance, the carbon dioxide filter system 100 may be configured to filter and/or breakdown nitrogen oxides (NOₓ). In a specific example, the carbon dioxide filter system 100 may include adding titanium dioxide (TiO₂) nanoparticles to the solvent 104, in addition to the water and/or the hydroxide. In this approach, the nanoparticles are part of the solvent 104 inside the reservoir 102 and may be excited by applying UV radiation from a UV radiation source 113, as shown in FIGS. 7-8. With this methodology, the nitrogen oxide molecules may be broken down, reducing the emission of this greenhouse gas into the atmosphere, while simultaneously capturing CO₂. In a more specific example, the carbon dioxide filter system 100 may include a two-cycle step before releasing the filtrated air, as shown in FIGS. 7-8. For instance, in a first cycle, polluted air may be injected into the reservoir 102 and mixed with the solvent 104 including water, a hydroxide, and TiO₂ nanoparticles. UV radiation may simultaneously applied to the solvent mixed with the polluted air to breakdown the NOx. Next, in a second cycle, the injection of polluted air may be ceased, and filtered air may be released from the exhaust port 108.

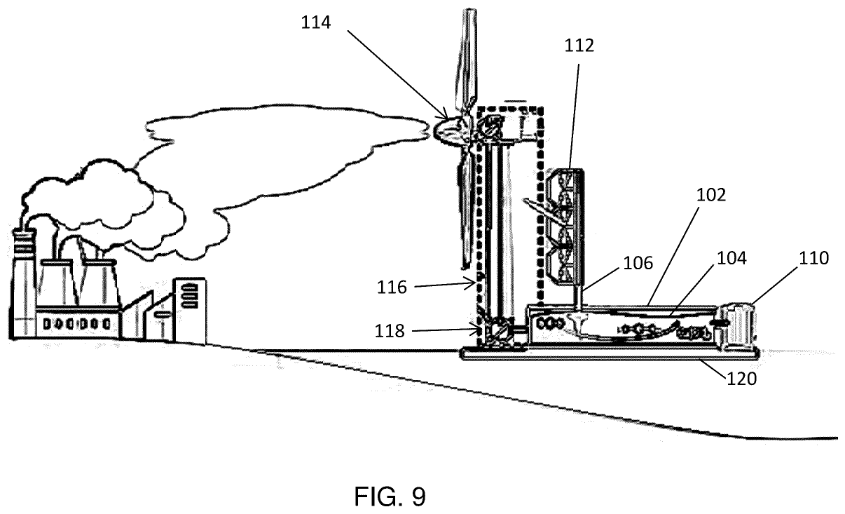

As shown in FIG. 9, the carbon dioxide filter system 100 may be coupled with a hydraulic wind turbine system 114, 116, 118 having a turbine 114, a hydrostatic transmission 116, and a hydraulic motor 118. The hydraulic wind turbine system 114, 116, 118 may be configured to energize the carbon dioxide filter system 100 while militating against the production of carbon dioxide. For instance, to increase the CO₂ capture efficacy, a tower of the wind turbine 114 may be made of concrete containing nanoparticles of TiO₂ to absorb CO₂. The blades of the turbine 114 may be coated with the photocatalytic coating that helps to clean the air from polluted gases like NOx.

Using the hydraulic wind turbine system 114, 116, 118, the carbon dioxide filter system 100 is able to generate electricity using a clean energy source, such as wind. Clean energy may be understood as an energy producing source that produces very little to no carbon dioxide. This clean energy may then be used to capture and filter carbon monoxide (CO) and/or carbon dioxide (CO₂). Wastewater from several industries, such as the corn industry wastewater production, is rich of hydroxides. Thus, the wastewater with hydroxides from the corn industry can be recycled/re-used in the solvent 104 as a CO₂ liquid filter.

The carbon dioxide filter system 100 including the hydraulic wind turbine system 114, 116, 118 may produce electricity while capturing CO₂ and producing CaCO₃ that can be used as a filler in concrete production or as raw material to produce cement. Utilizing the produced CaCO₃ in concrete production is only one non-limiting example of its possible utility. One skilled in the art may select other suitable uses for the produced CaCO₃, within the scope of the present disclosure. Eventually, the potential valorization of wastewater rich in hydroxides can add an extra value in terms of ecological and economical sustainability.

In certain circumstances, the carbon dioxide filter system 100 including the hydraulic wind turbine system 114, 116, 118 may be utilized in various environments. For instance, the carbon dioxide filter system 100 including the hydraulic wind turbine system 114, 116, 118 may have certain maritime applications. In a specific example, the carbon dioxide filter system 100 and hydraulic wind turbine system 114, 116, 118 may be coupled to a buoyant energy harvesting platform 120. In a more specific example, the hydraulic wind turbine system 114, 116, 118 may be configured to power the filtering process where the power output of the turbine transmission 116 is at an elevation substantially similar to an elevation of the reservoir 102. Advantageously, the relocation of the power output of the hydraulic wind turbine system 114, 116, 118 at a lower elevation, such as a ground level, may permit having power available without using the electric stage of the energy conversion. Also, the system provides the capability to control the output angular velocity since the pump and motor have different rotational speeds. Moreover, for offshore applications important savings in the (Levelized Cost of Energy) LCOE may be based on the modifications to the drivetrain of the wind turbine 114. Additionally, the energy harvested from wind may be used to recirculate the solvent 104 used as a filter and to inject the polluted air with CO₂ into the reservoir 102. The use of regular wind turbines, horizontal and vertical axis, are also considered to power the filtering process mostly to have multiple options depending on the wind resources available.

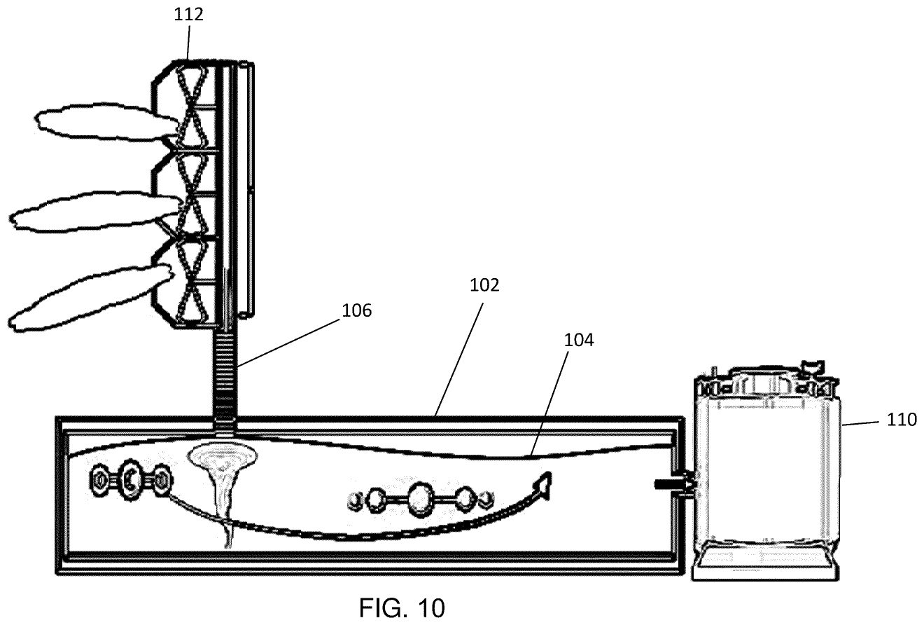

In certain circumstances, the solvent 104 may include various components. For instance, this reaction may capture CO₂ converting a mixture of water with lime to the point that the water is lime saturated plus extra lime. The incorporation of this CO₂ capturing liquid to a hydraulic system that pumps air with CO₂ concentrated will make a mixture of water and lime to become a liquid CO₂ capturing material, as shown in FIG. 10. The filtering process may be carried out in the reservoir 102 that works as mixing chamber, where the CO₂ is injected and mixed with the Ca(OH)₂. The process may be done in a closed loop that will be renewed from time to time in cycles when the filter has reached a maximum CO₂ capacity to be captured. Using the extraction fans 112, the generated and current CO₂ in the air is filtered reducing the current content of this gas from the environment. Alternatively, the process may include a high-concentrated hydroxide supply 119 to provide the solvent.

There are various applications of the present disclosure such as the decarbonation of the air in large, industrialized cities. For instance, provided as another non-limiting example, the atmosphere may be polluted with CO and CO₂ gases from the byproducts of cars combustion and industrial processes. With the implementation of the carbon dioxide filter system 100 powered by hydraulic and/or normal wind turbines, it is possible to have sustainable manufacturing and industrial processes. In one specific example, the carbon dioxide filter system 100 may be selectively moveable to reposition the carbon dioxide filter system 100 downwind from a carbon producing source.

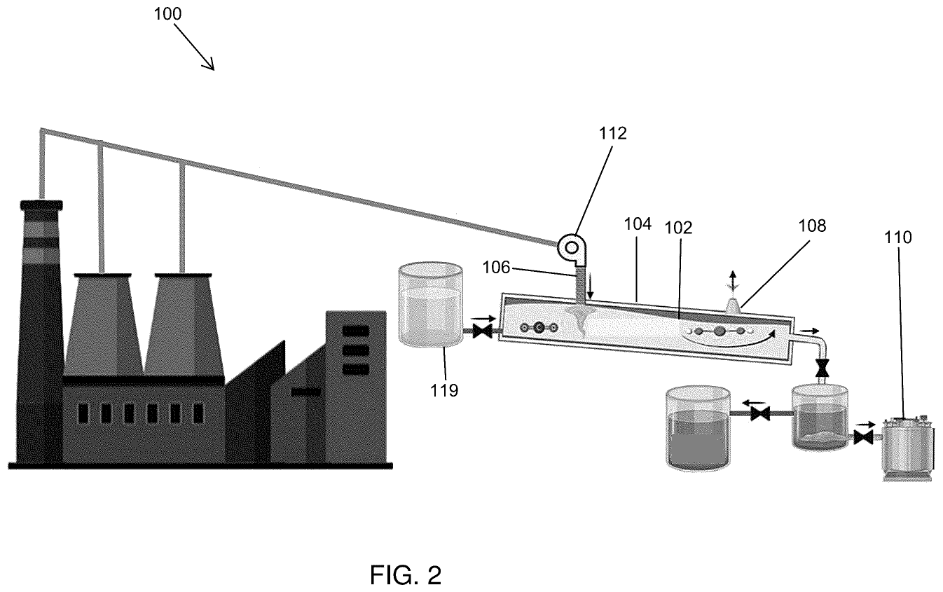

The air polluted with CO₂ may be filtered in the reservoir 102 before releasing clean air into the atmosphere, as shown in FIGS. 1-2. In the pre-final stage of the exhaust from the energy conversion process, the polluted air may be injected into the reservoir 102 where it is recirculated until the CO₂ reacts with the calcium hydroxide, and as a product CaCO₃ is obtained. The filter performance of the carbon dioxide filter system 100 may also be enhanced when high-concentrated CO₂ in the air is injected directly from the pollution source, rather than pulling polluted air from the atmosphere. For instance, the emissions from the pollution source may be directly coupled to the carbon dioxide filter system 100 through various means such as pipes, tubes, and/or ductwork.

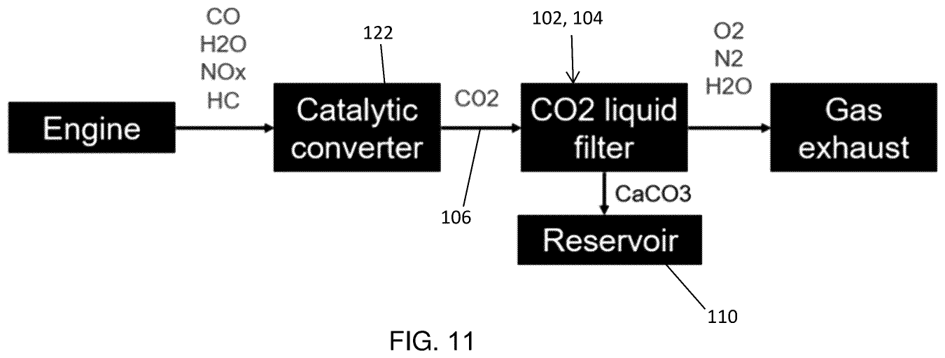

Emissions in transportation combustion processes have as primary products CO and CO₂. CO₂ represents up to 12% of the total pollutant released in emissions for diesel motors. For gasoline, this value reaches up to 13% of the total pollutant emissions. With those numbers on the table, integrating the proposed filter on the exhaust system may reduce the CO₂ concentration expelled to the atmosphere. The carbon dioxide filter system 100 may be placed after the catalytic converter 122, as shown in FIG. 11, where the CO is converted into CO₂, as a less harmful but still pollutant gas. This configuration may be adapted to multiple transportation vehicles such as cars, boats, and trains.

Known configurations of wind turbines have most of the components located inside the nacelle at a hundred meters height, which may be more expensive to maintain. The low-speed shaft, the gearbox, the bearings, and the generator are known to be placed high inside at the top of the wind turbine. These known configurations undoubtably have high costs in terms of fabrication, transport, assembly, operation, and maintenance. Moreover, the maintenance of the mechanical components at a high altitude is more expensive and complex than checking and changing components at ground level. This aspect is a very important point to consider to be analyzed in a long-term operation and costs. Two of the key components in known medium and large-size wind turbines are the gearbox and frequency converter, which represent around 18% of the total cost of the wind turbine. The gearbox is one of the heaviest, most expensive, and complex components inside the nacelle. The lifespan of the gearbox in continuous operation is diminished due to dynamic loads, vibrations, and constant fluctuations of wind speed. Further, torque fluctuations may lead to failure after around five years of continuous operation. Additionally, the gearbox is the component that generates the highest downtime after a failure, and it is in the group of components that generates 80% of the failures per year in wind turbines systems. Moreover, the other critical component, the frequency converter, also contributes drastically with around 13% to the overall failure rate per turbine per year. The carbon dioxide filter system 100 with the hydraulic wind turbine system 114, 116, 118 provides the advantage of have a direct drive train to power the fan(s) 112 further configured to inject the CO₂ to the reservoir 102.

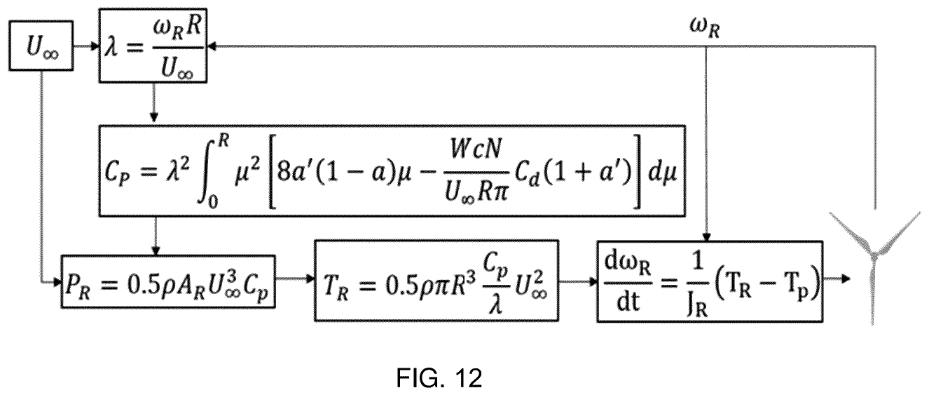

Having a certain wind speed data as an input is desired to estimate the torque delivered by the rotor of the wind turbine as the prime mover to the hydraulic pump. Since the test bench does not have a real rotor, the wind speed data is used to simulate the torque and speed provided to the pump. As shown in FIG. 12, with the value of wind speed U_{∞}, and the rotor diameter of the wind turbine that is desired to simulate, the tip speed ratio A is calculated. Based on the inertia and radius of the rotor, and the torque as well, the speed in the rotor will be a response to the torque generated. With the tip speed ratio calculated in real-time based on the wind speed, an ideal tip speed ratio is included with the aim to set the reference value where the power coefficient has the highest value. For this case, the pitch angle β remains constant since a 3.1 meters rotor diameter is considered, for which a pitch angle is constant.

The power coefficient is now calculated using the tip speed ratio in real-time, the ideal tip speed ratio, and the constant pitch angle. Considering the area of the rotor that is being simulated, the density of the air, wind speed, and the power coefficient previously estimated, the power extracted from wind are estimated. The mechanical power given by the rotor of the wind turbine considers the torque and the angular velocity, since we have estimated the power, the torque delivered to the pump connected to the shaft of the rotor is divided by the speed ω_{R}, as shown in FIG. 12.

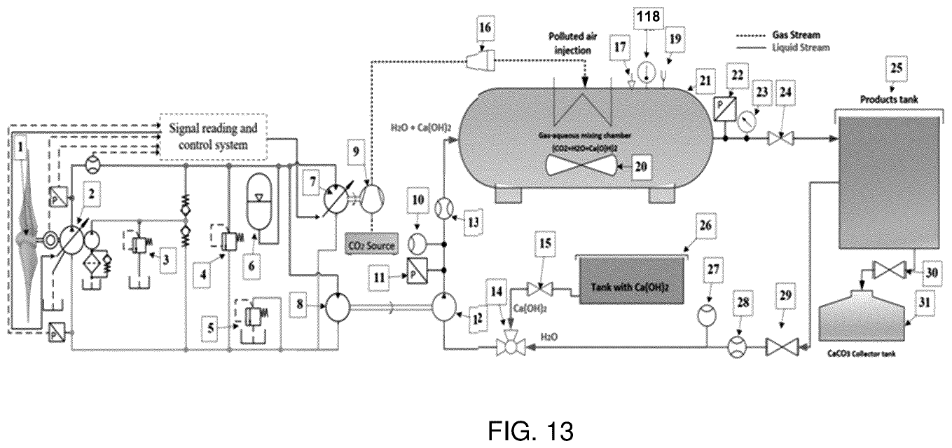

An ISO schematic of the carbon dioxide filter system 100 is shown in FIG. 13, further depicting the system 100 powered by the hydraulic wind turbine system 114, 116, 118. In other words, the power required to carry out the capturing process is provided by the hydraulic wind turbine system 114, 116, 118. This may be achieved by coupling a circulation pump 12 and an air compressor 9 to hydraulic motor(s) 118, which are the output of the hydraulic wind turbine system 114, 116, 118. With this, the stage that includes electric components is eliminated, along with one extra energy conversion stage. As shown in Table 3 on the following page, components of the integration of the carbon dioxide filter system 100 with the hydraulic wind turbine system 114, 116, 118 are provided as a non-limiting example.

TABLE 3

| Item | Component |
|---|---|
| 1 | Wind turbine rotor |
| 2 | Variable displacement axial piston pump |
| 3 | Charge circuit pressure relief valve |
| 4 | Main pressure relief valve |
| 5 | Low-pressure line relief valve |
| 6 | Hydraulic accumulator |
| 7 | Variable displacement hydraulic motor |
| 8 | Hydraulic motor |
| 9 | Gas compressor |
| 10 | Flow meter transducer |
| 11 | Pressure transducer |
| 12 | Circulation pump |
| 13 | Mechanical flow meter |
| 14 | 3-way valve |
| 15 | On-off valve |
| 16 | Gas flow meter |
| 17 | Air release valve |
| 18 | Thermometer |
| 19 | Thermocouple |
| 20 | Chamber mixer |
| 21 | Mixing chamber |
| 22 | Pressure transducer |
| 23 | Pressure gauge |
| 24 | On-off valve |
| 25 | Products tank |
| 26 | Calcium hydroxide tank |
| 27 | Flow meter transducer |
| 28 | Mechanical flow meter |
| 29 | On-off valve |
| 30 | On-off valve |
| 31 | Calcium carbonate tank |

In certain circumstances, the hydraulic wind turbine system 114, 116, 118 may be coupled with the fan 112 of carbon dioxide filter system 100 in various ways. For instance, the hydraulic wind turbine system 114, 116, 118 may be coupled via shaft-to-shaft to the fan 112. Advantageously, the shaft-to-shaft coupling requires the output of the hydraulic wind turbine system 114, 116, 118 to be located at or near a base or a ground surface of the hydraulic wind turbine system 114, 116, 118. Desirably, additional electrical stage components may be unnecessary with a simple shaft-to-shaft coupling configuration. Furthermore, power losses may be militated against due to energy conversion where the hydraulic wind turbine system 114, 116, 118 is coupled shaft-to-shaft to the fan 112 of the carbon dioxide filter system 100. One skilled in the art may also select other suitable ways for coupling the hydraulic wind turbine system 114, 116, 118 to the carbon dioxide filter system 100, within the scope of the present disclosure.

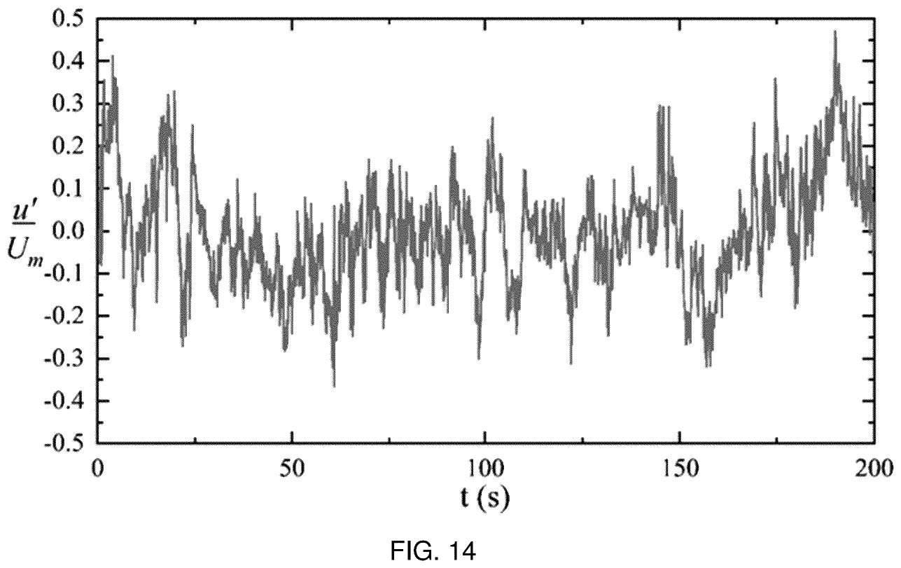

Provided as a non-limiting example, the transmission 116 was simulated following the input signal shown in FIG. 14. The input signal provides a wind speed profile that varied in a range of a minimum of 1.9 to a maximum of 10.18 m/s. Variations in wind speed reached around forty-eight percent.

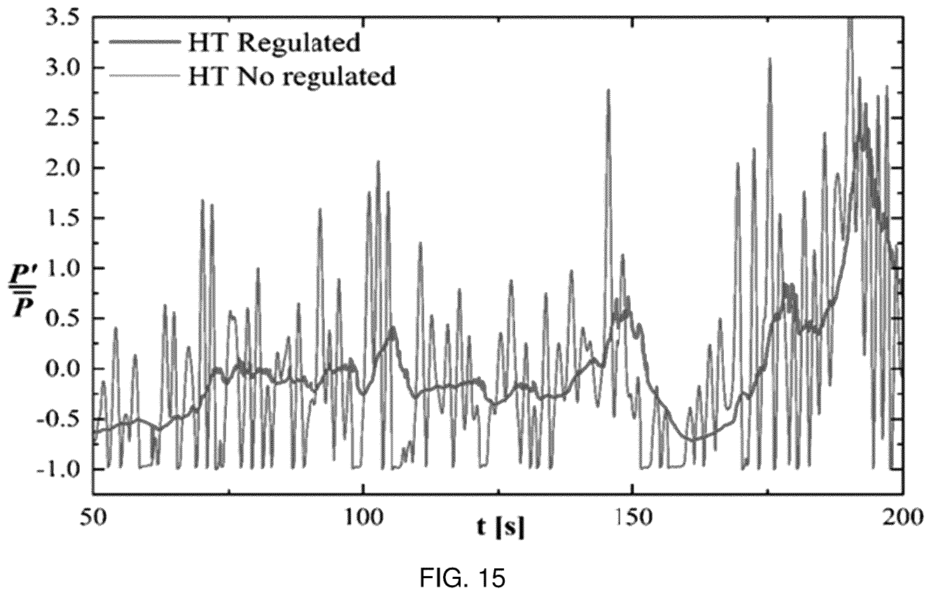

Under the conditions given by the wind speed profile used, a comparison of the power generated from the hydraulic wind turbine system 114, 116, 118 using the hydrostatic transmission 116 (HT Regulated) versus a non-controlled transmission (HT No regulated) was analyzed, as shown in FIG. 15. With continued reference to FIG. 15, the non-controlled transmission (HT No regulated) exhibited much greater fluctuations in signal compared to the hydrostatic transmission 116 (HT Regulated) of the present disclosure.

The average power obtained in the simulation was 2.3 kW and 1.83 kW for the rotor and the hydraulic motor, respectively. The fluctuations in magnitude were estimated in the range of 1.5 kW and 0.5 kW for the rotor and hydraulic motor, respectively. The magnitude of the fluctuations is directly related to the fluctuations in the wind speed. The overall efficiency of the transmission was around 78%. The carbon dioxide filter system 100 may further include a controller and/or an accumulator to provide a damping effect on the amplitude of the fluctuations.

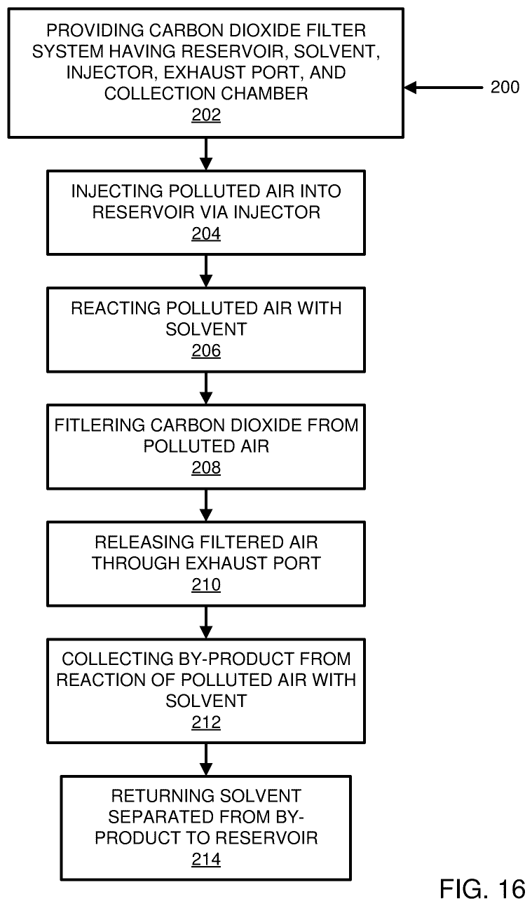

Various ways of using the carbon dioxide filter system 100 are provided. For instance, as shown in FIG. 16, a method 200 may include a step 202 of providing a reservoir 102, a solvent 104, an injector 106, an exhaust port 108, and a collection chamber 110. The solvent 104 may include a hydroxide disposed within the reservoir 102. The injector 106, the exhaust port 108, and the collection chamber 110 may each be coupled to the reservoir 102. Next, polluted air may be injected into the reservoir 102 of the carbon dioxide filter system 100. Afterwards, the polluted air may be reacted with the solvent 104. Then, the carbon dioxide may be filtered from polluted air. The filtered air may then be released from carbon dioxide filter system 100 through the exhaust port 108. Next, a by-product from the reaction of the polluted air with the solvent 104 may be collected in the collection chamber 110. In a specific example, the by-product may be calcium carbonate. In another specific example, the step of collecting the by-product includes a decantation process. Then method 200 may also include returning the solvent 104 separated from the by-product to the reservoir 102. In certain circumstances, the method 200 may further include energizing a fan 112 of the injector 106 with a turbine.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A carbon dioxide filter system configured to filter carbon dioxide out of polluted air, comprising:
a reservoir;
a solvent including a hydroxide disposed within the reservoir;
an injector coupled to the reservoir;
an exhaust port coupled to reservoir; and
a collection chamber coupled to the reservoir.

2. The carbon dioxide filter system of claim 1, wherein the injector includes to a fan that directs the polluted air to the reservoir.

3. The carbon dioxide filter system of claim 2, further comprising a hydraulic wind turbine system having a turbine, a hydrostatic transmission, and a hydraulic motor, wherein the hydraulic wind turbine system provides energy to the fan.

4. The carbon dioxide filter system of claim 3, wherein the hydraulic wind turbine system is coupled via shaft-to-shaft to the fan.

5. The carbon dioxide filter system of claim 3, wherein the turbine is at least partially coated with the photocatalytic coating to filter the polluted air.

6. The carbon dioxide filter system of claim 1, wherein the solvent includes titanium dioxide nanoparticles.

7. The carbon dioxide filter system of claim 6, further comprising a UV radiation source configured to excite the titanium dioxide nanoparticles in the solvent.

8. The carbon dioxide filter system of claim 3, wherein the carbon dioxide filter system is disposed on a buoyant platform with the hydraulic wind turbine system.

9. The carbon dioxide filter system of claim 1, wherein the hydroxide of the solvent is calcium hydroxide.

10. The carbon dioxide filter system of claim 1, wherein the solvent is recycled wastewater.

11. The carbon dioxide filter system of claim 9, wherein the polluted air reacts with the hydroxide of the solvent to form calcium carbonate.

12. The carbon dioxide filter system of claim 11, wherein the calcium carbonate is separated from the solvent and disposed in the collection chamber.

13. The carbon dioxide filter system of claim 12, further comprising a return line for recycling the solvent separated from the calcium carbonate back to the reservoir.

14. The carbon dioxide filter system of claim 1, wherein the carbon dioxide filter system is directly coupled to a carbon dioxide producing source.

15. The carbon dioxide filter system of claim 14, wherein the injector is coupled to a catalytic converter.

16. A method of using a carbon dioxide filter system configured to filter carbon dioxide out of polluted air from an atmosphere, the method comprising the steps of:
providing a carbon dioxide filter system having a reservoir, a solvent, an injector, an exhaust port, and a collection chamber, the solvent including a hydroxide disposed within the reservoir, the injector, the exhaust port, and the collection chamber are coupled to the reservoir;
injecting the polluted air into the reservoir;
reacting polluted air with the solvent;
filtering carbon dioxide from polluted air;
releasing filtered air through exhaust port; and
collecting a by-product from the reaction of the polluted air with the solvent.

17. The method of claim 16, further comprising a step of energizing a fan of the injector with a turbine.

18. The method of claim 16, wherein the by-product is calcium carbonate.

19. The method of claim 16, wherein the step of collecting the by-product includes a decantation process.

20. The method of claim 19, further comprising a step of returning the solvent separated from the by-product to the reservoir.
